(19) United States
(12) Patent Application Publication
(10) Pub. No.: US 2009/0007594 A1
(43) Pub. Date: Jan. 8, 2009

(54) CONDUIT COMPONENT FOR A POWER SUPPLY NETWORK, USE THEREOF, METHOD FOR TRANSPORTING CRYOGENIC ENERGY CARRIERS IN CONDUITS AND DEVICES SUITABLE THEREFOR

(76) Inventor: Anett Dylla, Alzenau (DE)

Correspondence Address: CONNOLLY BOVE LODGE & HUTZ LLP, 1875 EYE STREET, N.W., SUITE 1100, WASHINGTON, DC, 20006, US

(21) Appl. No.: 10/578,303

(22) PCT Filed: Nov. 1, 2004
(86) PCT No.: PCT/EP2004/012344

§ 371 Date: Sep. 23, 2008

(30) Foreign Application Priority Data
Nov. 4, 2003 (DE) 103 52 128.3

(51) Int. Cl. F25J 1/00; F28D 15/00; F16L 9/00

(52) U.S. Cl. 62/607; 165/104.21; 138/177

(57) ABSTRACT

What is described is a conduit component for a power supply network, comprising at least one first conduit for an at least partially liquid cryogenic energy carrier and at least one second conduit for a heat transfer medium liquid at the temperature of the liquid cryogenic energy carrier, said second conduit running parallel to the first conduit, and also heat exchangers, which are provided at the end of the second conduit and are in thermal contact with the first conduit, for evaporating or condensing the heat transfer medium during the extraction of the cryogenic medium from or during its introduction into the first conduit.

The conduit components can be used for setting up multifunctional power supply networks which allow the low-loss conduction of liquid cryogenic heat transfer media.

The invention relates to a conduit component for a power supply network, to a method for supplying consumers with cryogenic energy carriers and to conduits particularly suitable for carrying out the method.

On account of the limited stocks of fossil fuels and as a result of discussions about climate protection, the view is increasingly that it will be necessary, in the foreseeable future, to change over the growing energy demand to or supplement it with environmentally compatible energy carriers available in the long term.

A promising alternative for supplementing and changing over the energy economy based on fossil fuel is to use cryogenic energy carriers, for example an ecological hydrogen economy.

Hydrogen can be produced from renewable sources, such as, for example, solar energy, wind power or water power, and from biomass and is available to an unlimited extent without or with only low environmental pollution.

The arguments against these ideal concepts of using cryogenic energy carriers and, in particular, hydrogen as energy carriers of the future are that, under normal conditions, free hydrogen does not occur in nature, that is to say it has to be obtained by the use of energy. On the other hand, cryogenic energy carriers and, in particular, hydrogen are very easily and extremely volatile, so that considerable outlay is necessary for handling, transport and storage.

Under present-day market conditions, the economy of using cryogenic energy carriers and, in particular, the hydrogen economy is still markedly more costly than the established energy economy with power supply networks from central power stations and central and decentral heat generation from fossil fuels which are solid, liquid or gaseous at room temperature.

Although the state of the art in the recovery of energy from renewable sources is well advanced, the economic potential is the subject of highly controversial discussion. The argument against current-generating regenerative energy sources (for example, sun, wind and water) is that, because of the natural fluctuations in energy production, they cannot cover the fluctuations in consumption, and therefore the parallel reservation and provision of current from established power stations via network connections are necessary. This, in turn, presents the problem that electrical energy cannot be stored economically in large quantities and also has to be consumed at the moment of current generation. Nowadays, therefore, as a rule, renewable energies are not employed as an alternative, but in addition to conventional systems.

The investments in the plants for obtaining renewable energies also lead to markedly higher costs per kilowatt hour than the energy costs arising from conventional systems.

A large part of the consumption of fossil fuels is nowadays required for decentral heat generation (for example, private households) and for mobility (motor fuel). There are numerous developments aimed at introducing hydrogen as an alternative motor fuel for vehicles or as an energy carrier, for example, in combined heat and power plants for heating and power supply in households. These developments are driven, above all, by the advances in fuel cell technology. By means of hydrogen which can be obtained from the gasification of low-cost biomass, motor fuel costs per driven kilometer of the order of conventional motor fuels (for example, gasoline) can be achieved.

For a hydrogen economy for decentral heat, combined heat and power or motor fuel supply, however, it is necessary to have an infrastructure which entails high construction costs. In order to minimize the storage volume per stored or transported energy quantity, pressure vessels and cryogenic vessels must be used and in individual instances are already being implemented.

A further possibility is to construct conduit networks, such as exist for natural gas. In the industrial sector, conduit networks for gaseous hydrogen with transport lengths of several hundred kilometers are being used in individual cases.

There are also discussions, with regard to a changeover to the hydrogen economy, about using the natural gas conduit network with appropriate upgrading. This is possible in technical terms and corresponds essentially to the town gas networks employed in previous years. Town gas contains approximately 50% by volume of hydrogen.

The changeover that exists in natural gas networks cannot take place suddenly, but would have to be effected in part networks. These, in turn, would have to be such that the total of connected individual customers represents an economical hydrogen consumption quantity for which investment in hydrogen production is worthwhile on the principle of economy of scale. All consumers would have to change over their heating from natural gas to hydrogen at the same time. On realistic assumptions, this way would seem to be highly unlikely and would require enormous preliminary investments with a return on investment which would be difficult to calculate over time.

The idea of supplying consumers with liquid hydrogen as an energy carrier is basically known. This idea is discussed mainly in the field of means of transport, for example in DE-A-100 52 856. This publication proposes to use the heated evaporation of the cryogenic medium for cooling and condensing a medium, for example air, which stores energy by phase transition. The lifetime for the storage of the cryogenic medium can thereby be prolonged considerably. In the filling and extraction of cryogenic medium into and from the storage vessel, the energy-storing medium is used in order to improve the energy balance during storage.

Means of multiple energy generation/storage/supply network and domestic solar/environmental heat energy recovery systems has also already been described. One example of this is found in DE-A-100 31 491. However, this document deals in only very general terms with diverse possibilities for the configuration of such systems.

DE 692 02 950 T2 describes a transmission conduit for a cryogenic fluid. This has thermally coupled pipelines for the transport of cryogenic fluid and of a cooling fluid, which are wrapped in a foil which is connected to the cooling pipeline by means of connection devices.

DE 195 11 383 A1 discloses a natural gas condensation method which is coupled to an evaporation method for cryogenic liquid. A further development of this method is described in DE 196 41 647 C1.

DE 695 19 354 T2 discloses a discharge device with a supercooler for cryogenic liquid.

U.S. Pat. No. 3,743,854 discloses a system which allows the combined transmission of petrochemical liquids and electrical current.

Finally, DE-A-2,013,983 discloses a conduit system for the transmission of electrical energy, of refrigerating power or for the transport of industrial gases, which conduit system can be used for constructing a comprehensive conduit network with different functionalities.

All these previously known systems and components for these have hitherto not been able to gain acceptance in practice. One reason for this may be that it has hitherto been uneconomical to use them. There is therefore still a need for a conduit system which is simple to install and can be operated extremely economically.

Proceeding from this prior art, the object of the present invention is to provide a conduit component for a power supply network and a method for operating a power supply network, by means of which the technical, economic and social hurdles in setting up, step by step, an economy, in particular a hydrogen economy, run by means of cryogenic energy carriers can be overcome.

A further object of the present invention is to provide a conduit component for a power supply network and to operate said conduit component, the power supply network being capable of being set up, starting from island solutions, into a distribution network, successive renewable energy sources being capable of being integrated into said power supply network.

Yet a further object of the present invention is to provide a conduit component for a power supply network and to operate said conduit component, into which, in addition to energy carrier transport functions, further network functions, such as, for example, functions of information transmission, of the determination of operating variables of the power supply network or of current transport, can be integrated, thereby increasing the efficiency of the network and opening further future prospects.

The present invention relates to a conduit component for a power supply network, comprising at least one first conduit for an at least partially liquid cryogenic energy carrier, preferably for the connection of at least one store for the cryogenic energy carrier, with at least one consumer of the cryogenic energy carrier, said consumer being spatially separated from the store, and at least one second conduit for a heat transfer medium liquid at the temperature of the liquid cryogenic energy carrier, said second conduit running parallel to the first conduit, and also heat exchangers, which are provided at the ends of the second conduit and are in thermal contact with the first conduit, for evaporating or condensing the heat transfer medium during the extraction of the cryogenic medium from or during its introduction into the first conduit.

Thus, by virtue of the present invention, it is proposed to use the heat of evaporation of the cryogenic energy carrier for cooling and condensing a heat transfer medium, for example air, storing energy by phase transmission, in order to operate the conduit of cryogenic energy carriers, in that heat exchangers are mounted at the consumer and at the store for the cryogenic energy carrier. Via the heat exchanger provided to the consumer, the cryogenic energy carrier is evaporated and is heated to ambient temperature. The necessary thermal energy is extracted by means of the heat exchanger from a heat transfer medium, for example from an air stream, which is thereby cooled and, in particular condensed. This cooled and preferably liquid heat transfer medium is fed into the second conduit and can thus be transported in countercurrent as far as the feed location of the liquid cryogenic energy carrier. The cooled and preferably liquid heat transfer medium is available there, in turn, for cooling and, if appropriate, condensing the cryogenic energy carrier. Furthermore, the cooled and preferably liquid heat transfer medium acts, during transport through the second conduit, as a heat shield for the liquid cryogenic energy carrier transported in the first conduit. The energy balance of the system is thereby substantially improved. The losses are determined largely only by the pressure loss and the incidence of heat into the transport conduit, which can be minimized by good insulation, and by the exergy losses during heat exchange, that is to say during condensation and evaporation at the feed and withdrawal points.

In order to minimize the exergy losses, it is proposed to use microheat exchangers for the heat exchange. These are distinguished by very high surface/volume ratios and, although having a very small construction volume, can transmit very large heat quantities. Very small temperature differences can therefore be selected for the driving heat transmission gradient, minimizing the exergy losses. Additional advantages arise due to the very small construction volume and the high degree of reliability (“inherent reliability”), which particularly distinguishes the process engineering equipment in microtechnology (see Ehrfeld, W.; inter alia: Microreactors. WILEY-VCH Verlag GmbH, Weinheim, 2000).

The conduit component according to the invention may be a pipeline system, in which hydrogen can be transported in liquid, cryogenic form (for example, below 21 Kelvin corresponding to −253° C.). Hydrogen has in liquid form an energy density of approximately 2.3 kilowatt hours per liter of liquid. This is markedly lower than the energy density of oil which is approximately 10 kilowatt hours per liter, so that transport by tanker is less economical. This disadvantage disappears in the case of a continuous flow through pipelines, and only very small diameters of the pipelines are necessary in the liquid state per transported unit of power. This will be demonstrated by the example of a single-family house:

It is assumed that the annual energy consumption of heat and power is in total about 30 000 kWh/a. If, ideally simplified, a constant withdrawal is assumed, this would give a necessary transmission power of 3.42 kW in the case of annual period of use of 8760 hours. With the lower calorific value of 2.33 kWh per liter of cryogenic hydrogen, a throughflow of 1.47 liters per hour is calculated. At a selected flow velocity of between 0.1 and 0.5 meter per second, a pipe inside diameter of between only 1 and 2.5 mm is sufficient. In the case of a selected diameter of 2 millimeters or of a velocity of 0.15 meter per second, the pressure loss in a conduit with a length of 1 kilometer is approximately less than 1 bar on account of the low viscosity. This example illustrates that it will be possible for a person skilled in the art to find an optimum design of a large pipe network with very small conduit cross sections and with an economical operating range dependent on the pressure loss. A highly cost-effective and simple installation of a pipe network consequently becomes possible, for example comparable to the installation of electrical cables.

The power supply network according to the invention thus has preferably a first conduit, the inside diameter of which is smaller than or equal to 20 mm, preferably smaller than or equal to 10 mm, in particular smaller than or equal to 5 mm and, particularly preferably, smaller than or equal to 2.5 mm. Particularly preferably, the inside diameter of the second conduit is also smaller than or equal to 20 mm, preferably smaller than or equal to 10 mm, in particular smaller than or equal to 5 mm and, particularly, smaller than or equal to 2.5 mm.

Owing to the small dimensions of the conduit component according to the invention, this can be installed in already existing supply conduits, preferably in natural gas conduits.

In a further preferred embodiment, the first conduit of the conduit component according to the invention for a power supply network is connected to at least one store for cryogenic energy carrier and to at least one consumer for cryogenic energy carrier, a storage vessel for cryogenic energy carrier being connected, if appropriate, directly upstream of the consumer.

Cryogenic energy carriers which may be considered in terms of this description are all fluids which can be transported at low temperatures (as a rule, at temperatures of below 0° C.) in liquid form through conduit networks and which can be used in a consumer for the generation of energy. Examples of cryogenic energy carriers are hydrocarbons gaseous at room temperature, such as methane, ethane, propane, butane or their mixture, preferably natural gas, and, in particular, hydrogen. Mixtures of hydrocarbons and hydrogen which are gaseous at room temperatures may also be employed. These may contain further inert gaseous components, for example nitrogen or noble gases.

The conduction of the liquid cryogenic energy carrier through the power supply network may take place pressurelessly or under pressure. Pressure conduction is preferred.

The first and second conduit of the conduit component according to the invention for a power supply network may run, along their entire length, in a thermally insulating environment as a function of the type and temperature of the liquid cryogenic energy carrier to be transported. At higher transport temperatures, for example in the region of −50° C. or higher, the thermal insulation may, if appropriate, be dispensed with. At lower transport temperatures, it is recommended to cause a first and second conduit to run in a thermally insulating environment. The second conduit, in addition to the function of transporting the heat transfer medium for the recovery of thermal energy, has the function of a heat shield for the liquid cryogenic medium located in the first conduit.

A preferred embodiment of the conduit component according to the invention comprises a third conduit running parallel to the first and second conduit. This third conduit may serve for the return transport of evaporated heat transfer medium to the second heat exchanger or else for the transport of evaporated cryogenic medium. The liquid cryogenic medium may partially evaporate, for example, at the location of feed into the first conduit or else during transport to the first conduit (what is known as boil-off gas). Thus, different connections between the first conduit and the third conduit may also be selected, or the third conduit is connected to the first and second heat exchanger for the reception of gaseous heat transfer medium.

The power supply network according to the invention may also have, in addition to the conduits for transporting the cryogenic energy carrier, further elements which are known per se. Thus, in addition to storage devices and consumers for the cryogenic energy carriers, elements for measuring, monitoring, controlling and regulating the material flows, in particular for monitoring the temperatures and pressures, and devices for averting critical states, such as, for example, excess pressure reliefs, can be integrated. Elements, such as pumps, compressors or pressure transmitters for conveying the materials, may be provided at the feed locations. For the compensation of pressure losses, intermediate stations for conveying the media may be installed as a function of the transport lengths.

The power supply network according to the invention may comprise further elements for reprocessing and converting the energy carriers and the heat transfer media. At the consumer, the energy carrier can be led to a burner for heat generation. A preferred version is the supply of fuel cells for power generation. Combined power and heat generation is particularly advantageous.

By means of special devices, the energy carrier may be used for the fueling of vehicles.

By means of further elements of the power supply network, the air supplied can be at least partially broken down into its constituents at the feed location or at the outlet, so that nitrogen and/or oxygen is/are obtained in a higher concentration. Elements that dry the air and remove the water separated from the air may be provided at the air supply location.

The power supply network comprises, furthermore, devices for condensing the energy carrier, in which preferably the heat transfer medium is used for improving the efficiency of condensation. For this purpose, elements for heat exchange and/or elements for obtaining expansion work due to the heating of the heat transfer medium are to be integrated.

An extended version of the power supply network according to the invention includes the generation of the energy carrier, in particular of hydrogen. This may involve reformers for obtaining hydrogen from hydrocarbons or preferably electrolytic cells for the splitting of water. Particularly preferably, the power supply network may make use of electrolytic cells which are supplied with electrical current which is transported at least partially through the conduits according to the invention.

Further elements of the power supply network according to the invention may be devices for current generation, in particular from renewable energies, such as wind power or photovoltaic plants. By means of suitable elements, the current from these generators is fed at least partially into the conduit according to the invention. The current generated by means of these plants may be consumed directly and/or is supplied to electrolytic cells for obtaining hydrogen.

The power supply network according to the invention can be combined with data networks, process management systems assuming the regulation of the energy generation and storage systems, on the one hand, and of the consumer systems, on the other hand, the systems communicating with one another. Data transmission takes place preferably by means of data and signal lines which are integrated into the conduit system.

The fluctuating withdrawal of cryogenic energy carriers at the consumer may be compensated as far as possible by means of cryogenic buffer vessels at the conduit ends and/or at nodal points of a network.

The operation of the power supply network at very low temperatures, for example, at below 21 Kelvin, requires a very good insulation of the conduits, of the buffer vessels and of the other devices through which cryogenic energy carrier flows.

A wide diversity of methods and devices for heat insulation are known from the literature and industrial practice. Examples of these are to be found in VDI Wärmeatlas: Superisolationen [VDI Heat Atlas: Superinsulations]. Springerverlag, 8th edition 1997. Superinsulation foils are known for the insulation of low-temperature liquids. The term “superinsulations” is to be understood as meaning heat insulations, the overall thermal transmittance of which is markedly lower than that of stationary air. Such superinsulation foils are proposed, for example, for liquid hydrogen tanks in motor vehicles (cf. BMW AG: Zukunft Wasserstoff [BMW AG: Future Hydrogen]. Magazine, 2003).

The power supply network according to the invention may be implemented by means of rigid pipelines.

Preferably, however, pipelines in which the possibility of cable-like installation is not appreciably restricted are used. If thin and thermally insulated pipelines are employed, the insulation should not appreciably increase the cost of the conduits and should be simple to handle under the rough conditions of field installation. Furthermore, the operating costs arising due to low-temperature cooling and to heat and pressure losses are to be minimized. Flexibility is to be ensured for installation in curving terrain. A cost-effective form of delivery and installation technology may be assisted, for example, in that long lengths of the conduits can be wound on drums. Very simple assembly and on-the-spot insulation are to be possible at the connection and branching points. The outlay for compensating the expansion or contraction of the pipeline materials as a result of pronounced temperature differences is to be as low as possible.

A series of approaches to a solution are already available for these purposes. A vacuum is required for good insulations in the low-temperature range.

The material of the first and second conduits may be a metal or it may be plastic. The first and second conduits are preferably selected such that they are flexible at room temperature and can be installed simply. The flexibility of the first and second conduits may be obtained in a way known per se by means of the type of material and/or by means of the dimensioning of the conduits.

A preferred embodiment of the power supply network according to the invention comprises a first and second conduit which are surrounded by a casing and form a pipeline in which a vacuum is formed after installation and due to the cooling of the pipeline during operation. Pipelines of this type comprise a gastight space which is formed by the casing and which, before the vacuum is generated, is filled with a gas, the vapor pressure of which decreases sharply during cooling. A gas is preferably used which, during cooling, is transferred by condensation from the gaseous state directly into the solid state of aggregation. Carbon dioxide is the most suitable for this purpose.

Pipelines of the type described above are basically known from EP 0 412 715 A1. This publication describes partial vacuum insulation, using condensed carbon dioxide. In this case, however, carbon dioxide bubbles are included in a polyurethane layer with which the low-temperature pipe is thinly coated. A powder charge containing inert gas is located between this coating and an outer pipe.

In a preferred embodiment of the power supply network according to the invention, pipelines are used which comprise first, second and, if appropriate, third conduits running parallel to one another, at least the first conduit, preferably the first and the second conduit, being sheathed by at least two spaced-apart insulation foils which form an evacuatable space in which a material, preferably carbon dioxide, solidifying by condensation at low temperatures and/or a gas removable by adsorption onto a getter material and also a getter material are located, and the first, second and, if appropriate, third conduit and insulation foils being surrounded by a thermally insulating sheath.

Suitable combinations of getter material/adsorbable gas are, for example, metal hydride/hydrogen.

In a preferred embodiment, at least one of the insulation foils is coated with a thin metal layer.

Particularly preferably, the first, second and, if appropriate, third conduit may additional also be sheathed with a layer of foam material.

Particularly preferably, the evacuatable space formed between the insulation foils also contains, in addition to the condensable gas, a finely particulate insulation material, in particular powdered silicic acid, mineral fibers or finely particulate foam materials.

Pipelines of this type are novel and are likewise the subject of the present invention.

The space in which evacuation by condensation takes place must in this case essentially maintain its initial volume, so that the vacuum can be built up. For the production of such a space, vacuum insulation foils known per se are used, which are wound or extruded as vacuum bands or as vacuum plate foils around pipelines. In these insulation foils, very good heat insulators, such as, for example, porous powdered silicic acid or mineral fibers, are closed, vacuumtight, between two foil surfaces. According to the prior art, evacuation is carried out during the production of the composite structure with the insulation foils. The filler formed by the porous material thereby becomes relatively rigid. Winding around the pipes becomes difficult. A large number of kinks forming uncontrollable heat bridges may occur. There is a risk that evacuated rigid insulation foils are damaged during further processing for winding around the pipes, during transport and during the installation of the insulated pipes and lose their insulation action.

These disadvantages are overcome if the vacuum of the insulation arises only when the installed conduits are in the operating state in situ. For this purpose, the pore space between the insulation foils is sealed during production, for example, with carbon dioxide which is present as a solid (“dry ice”) in the low-temperature state.

At ambient temperatures, the insulation foils, which are filled, for example, with powdered silicic acid, and also the conduits sheathed by the insulation foils are therefore soft and easily processable. Such conduits may be wound on drums and are thus “drum-windable”. Only when the conduits are installed and are put into operation is the vacuum formed by means of which the insulation becomes rigid formed. On the construction sites, connection and branching points can be wound around with such foil bands, thus greatly simplifying the assembly and nevertheless giving rise to a good insulating action when the conduits and devices are in operation. For protection against damage and to maintain leaktightness, a wide diversity of possibilities are open to a person skilled in the art in order to ensure long lifetimes of the installed pipelines. These may be protective casings made from metal, similar to those used in district heat pipelines, or plastic sheathings.

Multiple-ply versions and further known measures, such as heat shields and metal coatings of the foils, may further improve the action and also contain, in addition to the heat insulation, radiation and electric insulations.

One disadvantage of transporting liquid cryogenic energy carriers through pipelines is the additional outlay in terms of condensation energy. In relation to the calorific value of hydrogen, an approximately 30 to 40% energy outlay is required for condensation. This disadvantage can be reduced considerably by means of the measures described above. The very small conduit diameters and the flexible insulation methods described above make it possible to combine two or more thin pipelines in one composite structure.

Such composite conduits are known as flexible multi-pipelines from deep-sea oil conveyance and are described for example, in U.S. Pat. No. 6,102,077. However, the previously known pipeline system are not suitable in the design for use in the case of low-temperature conduction.

A further transport conduit for cryogenic fluids which is suitable for use in the power supply network according to the invention is described in DE-A-199 06 876. In this, two individual pipes are used which are thermally insulated from one another and are jointly encased preferably with a metal pipe. The inner volume of the tubular casing is evacuated, and material having low coefficient thermal expansion is used for the inner pipe.

In the power supply network according to the invention, expansion compensation must not be dispensed with. Owing to the flexible installation, natural expansion sections, such as are known in conventional pipeline installation, may be provided without any appreciable cost disadvantages.

The use of thin pipelines for transporting cryogenic liquids, simple insulation by means of in-situ evacuation, flexible installation and the combination of a plurality of pipes into a multi-pipeline makes it possible to overcome the disadvantage of the condensation outlay.

According to the invention, it is proposed to combine at least two pipelines in a route in which one pipeline transports the liquid cryogenic energy carrier, preferably hydrogen, and a further cryogenic liquid is transported as a heat transfer medium in countercurrent in a second pipeline. This second cryogenic liquid is preferably nitrogen or, in particular, air.

The heat transfer medium is fed into the second conduit preferably at the location of the extraction of the cryogenic energy carrier, via a heat exchanger, from a store or from the surroundings, at the same time with at least partial condensation, flows in countercurrent through the second conduit to the cryogenic energy carrier located in the first conduit, and, at the location of the feed of the cryogenic energy carrier into the first conduit, is discharged via a heat exchanger out of the second conduit into a store or into the surroundings, at the same time experiencing evaporation. Alternatively, in a third conduit which is thermally insulated from the first and second conduit, the heat transfer medium may be recirculated from the heat exchanger at the location of the feed of the cryogenic energy carrier in the first conduit to the heat exchanger at the location of the extraction of the cryogenic energy carrier from the first conduit and may be fed into the second conduit there again.

In a particularly preferred embodiment, a third conduit is provided, in which gaseous cryogenic energy carrier, what is known as boil-off gas, is transported. This embodiment further improves considerably the energy balance of the conduit component according to the invention.

A further particularly preferred embodiment of the invention relates to the transport of liquid hydrogen as a cryogenic energy carrier; in this case, the hydrogen is conducted at the location of the second heat exchanger and/or at discharge locations out of the first conduit into the third conduit via a catalyst which accelerates the conversion of parahydrogen into orthohydrogen. The conversion of parahydrogen to orthohydrogen is endothermal. By means of a locally controlled uptake of the conversion energy, the efficiency of the system can be increased even further.

The invention also relates to a method for the conduit transport of cryogenic energy carriers, comprising the steps:
i) feed of a gaseous and/or liquid cryogenic energy carrier into a first conduit,
ii) condensation or cooling of the liquid cryogenic energy carrier at the location of the feed into the first conduit by transmission of thermal energy from the cryogenic energy carrier to a liquid heat transfer medium in a second conduit which is connected to a first heat exchanger, with the result that the heat transfer medium evaporates and is discharged from the second conduit,
iii) transport of the liquid cryogenic energy carrier through the first conduit,
iv) transport of the liquid heat transfer medium through the second conduit in countercurrent to the cryogenic energy carrier,
v) evaporation of the liquid cryogenic energy carrier at the location of the discharge from the first conduit by transmission of thermal energy from the gaseous heat transfer medium to the liquid cryogenic energy carrier in the first conduit which is connected to a second heat exchanger, with the result that the heat transfer medium condenses and is fed into the second conduit, and
vi) discharge of the gaseous cryogenic energy carrier from the first conduit.

In a preferred embodiment of the method, the gaseous heat transfer medium is introduced from the surroundings into the second conduit at the location of the second heat exchanger and is discharged into the surroundings at the location of the first heat exchanger.

In a further preferred embodiment of the method, the gaseous heat transfer medium is recirculated, in a third conduit which is thermally insulated from the first and second conduit, from the first heat exchanger to the second heat exchanger and is fed there in condensed form into the second conduit again.

In yet a further preferred embodiment of the method, gaseous energy carrier which has occurred due to the evaporation of cryogenic energy carrier is transported in a third conduit running parallel to the first and second conduit. The feed of the gaseous energy carrier may take place at one or more desired points in the conduit network, for example at the location of the feed of the cryogenic energy carrier into the first conduit, or a connection to the third conduit may be provided at one or more points on the first conduit, evaporated energy carrier being fed into the third conduit by means of said connection. The gaseous energy carrier in the third conduit may be discharged at both ends of this conduit, in order to be used at the location of the consumer, for example, together with the evaporated energy carrier discharged from the first conduit, or in order to be condensed at the location of the feed of the cryogenic energy carrier and to be fed into the first conduit.

The energy recovery system described affords additional options for a hydrogen economy. The condensation of the air at the consumer may be utilized, for example, in order to separate the nitrogen and the oxygen of the air. The concentrated oxygen may be consumed, for example, in a fuel cell, thus making the fuel cell more efficient. In this case, only the liquid nitrogen or low-oxygen air is transported back to the location of hydrogen condensation. It is also conceivable that the liquid aid is collected and broken down at a central point and that the oxygen and the nitrogen are supplied from there for further uses or for sale.

The cryogenic transport of liquid and the combination of two or more pipelines affords the possibility of equipping the conduit system with additional transmission functions which further increase profitability.

Multifunction conduits, what are known as umbilical pipes, which combine material, current and signal conduits, are known. The cryogenic conduits described can be extended on the same principle. In the simplest instance, on the assumption of mutual insulation, electrically conducting individual conduits may be used as electrical conductors for current or signal transmissions, so there is no need for any additional cables.

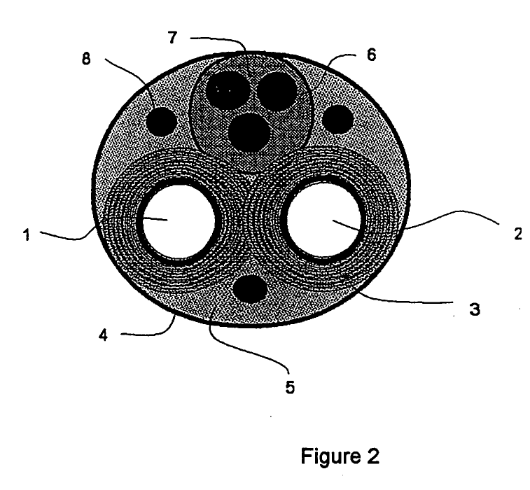

The special design of the multifunction conduits (umbilical) in combination with the material transport of cryogenic liquid energy carriers is designated hereafter as “cryumbilical”. A variant with parallel material, current and signal conduits is shown in FIG. 2. Electrical conductors or else glass fibers may be considered as signal conductors.

As a particularly advantageous version of cryumbilicals, it is proposed to utilize the low temperatures to below 21 K, present in any case for the transport of hydrogen, at the same time for super-conduits for current and signal transmission. High-temperature superconduits which lose their electrical resistance even at −135° C. are known.

Materials which are effective above a temperature of liquid air, for example at 80 Kelvin, are sufficient here. The lower the temperature is, the more such materials are available. Such superconductors may be mounted in parallel in thermal contact with the low-temperature pipelines, for example by the pipelines being wound around or coated with these materials or as separate cables.

It is known that, by means of superconductors, the transmission power of high-frequency energy is markedly increased and the losses fall drastically. Demonstrations of superconductor components for electricity networks with good results are also known. Thus, Ullmann's Encyclopedia of Industrial Chemistry, 5th Edition, Vol. A 25, p. 734, illustrates a three-phase high-temperature superconduction cable, in which liquid nitrogen is used for cooling.

These developments have the disadvantage that the low temperature which is necessary entails additional outlay in technical and economic terms.

It is known from DE 195 01 332 A1 to use coaxial pipe systems as superconducting high-frequency cables, liquid nitrogen which flows in the inner pipe of the coaxial system being used for cooling.

In contrast to this, by means of the power supply network according to the invention, broad application and the supply of any desired consumers, such as private households, are to be economically possible. In the preferred version proposed here, involving the simultaneous use of the conduits for cryogenic energy carriers and for current or signal transmission, this disadvantage is overcome because there can be a division of costs.

The combination of transmission functions affords further advantages for a conduit network of cryogenic energy carriers. At any point of the conduit network, in the multifunctional version, electrical energy and the possibility of signal transmission for measurements, control and regulation purposes are available. Consequently, for example, functions can be set up which further increase the operating reliability and functionality of the conduits and network. These may be, for example, valve controls at branching points or the monitoring of operating parameters, such as pressure, temperature or leakages. Since an introduction of heat via the insulation cannot be ruled out completely, it is also conceivable to operate refrigerating machines at periodic intervals. Cold generators operating on the Gifford/McMahon principle are recommended as a special version. They are distinguished by high reliability and a long lifetime and are therefore employed, inter alia, in space travel.

In a special version of the conduit component according to the invention, a pulsation tube, also called a pulse-tube cooler, is used as heat exchanger. A highly advantageous application and version of pulse-tube coolers arises in combination with the cryumbilical described above.

The invention is illustrated in more detail in the figures. These are not intended to limit it.

In the Drawing:

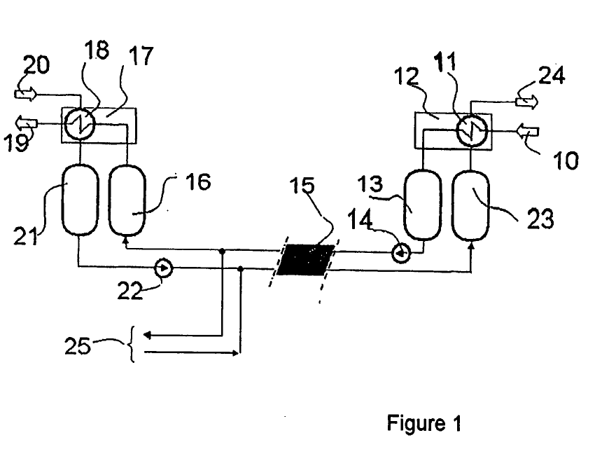

FIG. 1 shows a basic diagram of the power supply network according to the invention,

FIG. 2 shows an embodiment of a “cryumbilical” with parallel material, current and signal conduits in cross section,

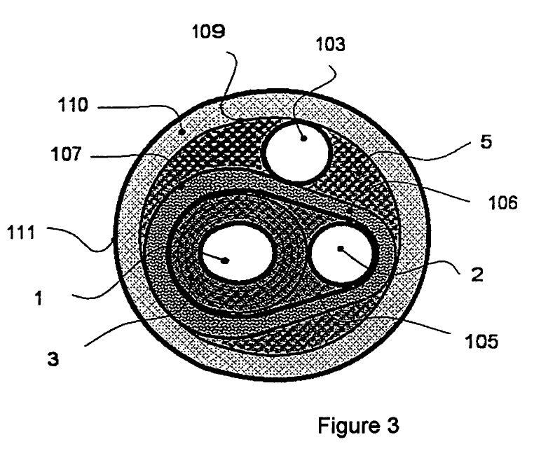

FIG. 3 shows a further embodiment of a “cryumbilical” with parallel material conduits and with a conduit for boil-off gas in cross section,

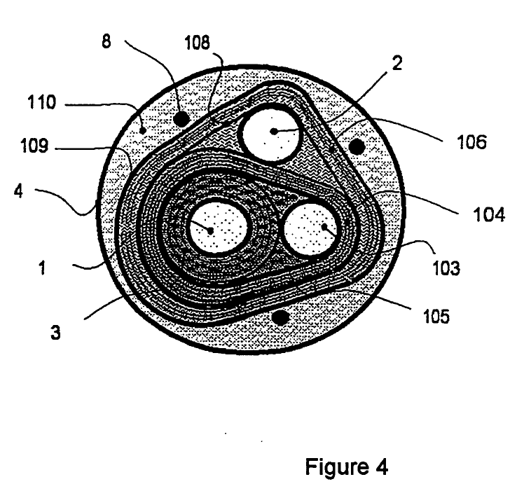

FIG. 4 shows an embodiment of a further “cryumbilical” with parallel material, current and signal conduits and with a conduit for boil-off gas in cross section,

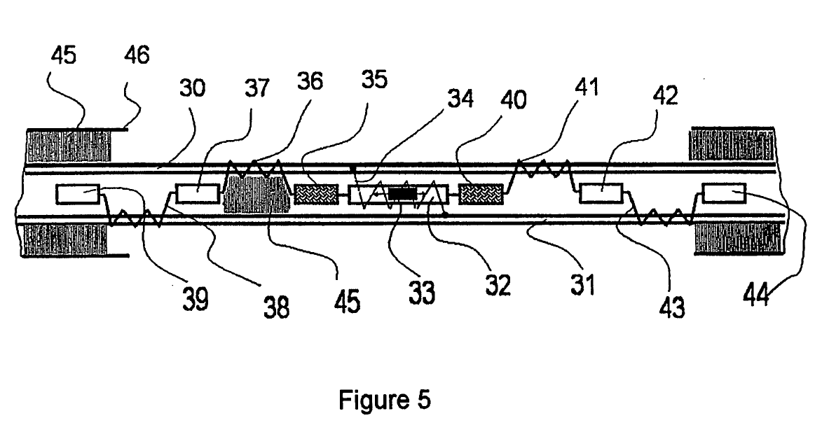

FIG. 5 shows an embodiment of the integration of a double pulsation tube into a cryumbilical in longitudinal section.

FIG. 1 shows, greatly simplified, a system variant in which hydrogen gas is fed in via a hydrogen gas supply (10), is condensed, using a heat exchanger (11), in a condenser/evaporator (12) and is conducted to the consumer/consumers via a pipeline system (15). Gaseous air (20) is conducted in countercurrent via an air supply through a heat exchanger (18) located in a condenser/evaporator (17), is condensed there, is recirculated in the pipeline system (15) and used via heat exchanger (11) for heat absorption during the condensation of hydrogen and is discharged from the system as gaseous air (24). The evaporation of the liquid hydrogen takes place, parallel to the condensation of the air, in the condenser/evaporator (17), this hydrogen being delivered to the consumer as gaseous hydrogen (19).

FIG. 1 shows, furthermore, buffer vessels (13, 16, 21, 23) for hydrogen or air and pumps (14, 22). Moreover, the pipeline system (15) also contains branches (25) to further consumers.

FIG. 2 shows an example of a cryumbilical in cross section. What are illustrated are a pipeline for cryogenic hydrogen (first conduit; (1)), a pipeline for cryogenic air (second conduit; (2)), a foil insulation with CO₂ inclusion (3), the outer casing (4), insulating material (5), electrical cables (6), electrical insulation (7) and signal conduits (8).

FIG. 3 shows a further example of a cryumbilical in cross section. What are illustrated are a pipeline for cryogenic hydrogen (first conduit; (1)), a pipeline for a cryogenic heat transfer medium, for example air or nitrogen (second conduit; (2)), a pipeline for a gaseous energy carrier, for example boil-off gas (third conduit; (103)); a foil insulation with CO₂ inclusion (3); a heat shield (105) made from heat-conducting material, for example a copper foil; a superinsulation (106) of the heat transfer medium conduits; gastight intermediate sheaths (107); an insulation (5); a further gastight intermediate sheath (109); an insulating outer casing (110); and an outer protective layer (111).

The cryumbilical illustrated in FIG. 3 has three material flow conduits. Cryogenic hydrogen is carried in the first conduit (1). This conduit is encased with a foil insulation (3). A second conduit (2) carries cryogenic air and is encased, jointly with the insulating first conduit, with a heat-conducting material (105) which acts as a heat shield. Heat which penetrates from outside and impinges onto the heat shield is conducted at least partially through the heat-conducting material (105) to a second pipeline (2). The heat transfer medium (for example liquid air) in the second conduit absorbs this heat and transports the heat away. In this case, heat can be absorbed as a result of the partial evaporation of the air. The evaporated air is removed (not illustrated here) from the system at intervals along the pipeline. The heat shield (105) is, in turn, packed into a superinsulation (106) which is closed by means of a gastight sheath (107). In this version, a third conduit (103) receives gaseous hydrogen which is removed (not illustrated here) from the first conduit along the transport path. Further insulation materials (110), a further gastight sheath (109) and an outer protective layer or the outer casing (111) are illustrated.

The cryumbilical illustrated in FIG. 4 likewise has three material flow conduits. In contrast to the example in FIG. 3, the conduit (2) for the cryogenic heat transfer medium and the conduit (103) for the gaseous energy carrier are interchanged. A further heat shield (108) encases the inner insulated conduits of the liquid energy carrier (1) and of the gaseous energy carrier (103). The outer heat shield is surrounded by a superinsulation (106) and a gastight sheath (109). The conduit (103) receives gaseous hydrogen which is removed from the first conduit (1) along the transport path or which is fed and recirculated into the conduit for the gaseous energy carrier at the location of the extraction of the liquid energy carrier. In the version, a temperature of the gaseous energy carrier is established which lies between the temperature of the liquid energy carrier in the conduit (1) and that of the heat transfer medium in the conduit (2).

FIG. 5 illustrates an embodiment of the integration of a double pulsation tube into a cryumbilical in longitudinal section.

FIG. 5 shows a conduit (30) for cryogenic hydrogen, a conduit (31) for liquid air, a compressor cylinder (32), a compressor piston (33), an electromagnet (34), regenerators (35, 40), coolers (36, 41), pulse tubes (37, 42), heat discharges (38, 43), buffers (39, 44), an insulation (indicated at 45) and an outer casing (46).

A version of a pulse-tube cooler consists of a compressor, a regenerator, a pulse tube and, if appropriate, a store. The refrigerant used is preferably helium gas. The compression of the helium may even be carried out very far away. In this case, however, valves for the inlet and outlet of the regenerator are necessary, which admit the compressed gas and discharge the expanded gas in a clocked manner. In the embodiment illustrated in FIG. 5, the compressor is located in the immediate vicinity of the pulsation tube. When the compressor operates as an oscillating piston compressor, valves are not required. One disadvantage, however, is that leakages may occur between the cylinder and the piston. Due to the loss of helium, the heat pump action is lost. This disadvantage is overcome by means of a mirror-symmetrical design of the pulse-tube cooler with a compressor (32, 33) and two pulsation tubes (37, 42), including two regenerators (35, 40). The oscillation of the piston (33) is generated by means of an externally applied electrical magnetic field (34) having an alternating force action. The control of this drive is not illustrated in FIG. 5. It is clear that the space filled with helium is closed, and no leakage from the overall system can occur. Minor internal leakages between the piston and cylinder may be permitted. This allows sufficiently large tolerances between the piston and cylinder. Production becomes simpler, and functional reliability (“piston jams”) is increased. A similar version is described in DE 42 20 640 A1. In this example, a common expansion machine in a double-acting piston/cylinder arrangement is also proposed. Integration into heat-discharging and heat-absorbing surroundings is not described.

It becomes clear from the embodiment, illustrated in FIG. 5, for the integration of a double pulsation tube into a cryumbilical that, in this combination, a heat pump system in very small radial dimensions becomes implementable. The volume and consequently the power of the system can be extended in the axial direction. Multistage versions may be mounted axially one behind the other.

In the combination with a cryumbilical, in which, in addition to the hydrogen conduit (30), there is at least one second pipeline (31) which is operated at a low temperature level, for example by the transport of liquid nitrogen or liquid air, the heat pump used has to overcome only a slight temperature difference, in that the heat (36, 41) absorbed from the hydrogen conduit is discharged (38, 43) to the second conduit at a higher level. The material, for example nitrogen, flowing in the second conduit transports this heat away. The heat pump system can thereby be operated, single-stage or multistage, with small temperature differences and thereby becomes highly efficient.

It was proposed above to use buffer stores, for example, at branching and nodal points of a cryumbilical network. These buffer stores can advantageously be equipped with heat exchangers, so that heat pumps can be integrated even at these points.

The methods and devices for the transport of liquid hydrogen may, in principle, also be used for the transport of liquid natural gas. Natural gas boils at about 115 Kelvin, so that, restrictively, superconduction becomes possible only when materials in this temperature range are found. Nevertheless, even in this case, current conduction via the metallic pipelines or via parallel cables in the cryumbilicals is possible. The installation of cryumbilicals for the transport of liquid natural gas may be an attractive interim solution for the initially described changeover to a hydrogen economy. Thus, for example, households can already be connected to a cryumbilical network and the gas heating systems can be operated according to the prior art.

In summary, it is proposed to transport fuels, in particular hydrogen, over long distances in cryogenic form through pipelines, in that a heat pump process is superimposed on the transport of the fuel. In this case, very long distances between the fuel extraction location and the feed location are overcome. The circuit of the heat pump process is materially separated, energy recovery taking place by liquid/gaseous and gaseous/liquid phase alternation between the cryogenic materials transported.

It is proposed to use preferably microheat exchangers for heating and evaporation or for cooling and condensation.

Furthermore, it is proposed to provide the low-temperature conduits with a heat insulation in which the insulation evacuation occurs only at the time of operation in situ, in that the gastight cavity of insulation is sealed under ambient conditions with a gas which at least partially freezes into a solid at the low temperatures. Condensing carbon dioxide is preferably used.

Furthermore, it is proposed to combine at least two conduits in a common route and to use the pipelines themselves for the transmission of electrical energy and/or information signals and/or to integrate additional cables for current and signal transmission into the route. It is proposed, furthermore, to utilize the low-temperature state of the fuel pipelines in order to employ superconducting materials for electrical energy and/or signal transmission.

The multifunctional design of the fuel conduit makes it possible, along the route, to operate refrigerating machines which compensate cold losses. Moreover, measurement, regulation and control functions may be integrated.

1-44. (canceled)

45. A conduit component for a power supply network, comprising at least one first conduit for an at least partially liquid cryogenic energy carrier and at least one second conduit for a heat transfer medium, said second conduit running parallel to the first conduit, and also heat exchangers, which are provided at the ends of the second conduit and are in thermal contact with the first conduit, for heating and/or evaporating or cooling and/or condensing the heat transfer medium during the extraction of the cryogenic medium from or during its introduction into the first conduit or at one end of the second conduit a heat exchanger is provided, which is in thermal contact with the first conduit, for cooling and/or condensing the heat transfer medium during the extraction of the cryogenic medium from the first conduit and at the other end of the second conduit elements are provided for obtaining expansion work due to the heating and/or evaporating of the heat transfer medium.

46. The conduit component as claimed in claim 45, characterized in that microheat exchangers are provided as the first and/or second heat exchanger.

47. The conduit component as claimed in claim 45, characterized in that the inside diameter of the first conduit is smaller than or equal to 20 mm, preferably smaller than or equal to 2.5 mm.

48. The conduit component as claimed in claim 47, characterized in that the inside diameter of the second conduit is smaller than or equal to 20 mm, preferably smaller than or equal to 2.5 mm.

49. The conduit component as claimed in claim 45, characterized in that this is installed within an already existing supply conduit.

50. The conduit component as claimed in claim 45, characterized in that the first conduit is connected to at least one store for cryogenic energy carrier and to at least one consumer for cryogenic energy carrier, a storage vessel for cryogenic energy carrier being connected, if appropriate, directly upstream of the consumer.

51. The conduit component as claimed in claim 45, characterized in that the first and second conduit run, along their entire length, in a thermally insulating environment.

52. The conduit component as claimed in claim 45, characterized in that cryogenic buffer vessels are provided at the conduit ends and/or at nodal points.

53. The conduit component as claimed in claim 45, characterized in that the material of the first and second conduit is metal or plastic.

54. The conduit component as claimed in claim 53, characterized in that the first and second conduits are selected such that they are flexible at room temperature.

55. The conduit component as claimed in claim 45, characterized in that this comprises a third conduit running parallel to the first and second conduit.

56. The conduit component as claimed in claim 55, characterized in that the third conduit is provided for the transport of evaporated cryogen medium and is connected to the first conduit.

57. The conduit component as claimed in claim 45, characterized in that the first and/or second conduit individually or combined are surrounded by a casing in which a vacuum is formed after installation and due to the cooling during operation, in which casing a gastight space is formed which, before the vacuum is generated, is filled with a gas, the vapor pressure of said gas decreases sharply during cooling, preferably is filled with a gas which during cooling is transferred by condensation from the gaseous state directly into the solid state of aggregation.

58. The conduit component as claimed in claim 45, characterized in that this has a first, second, and, if appropriate, third conduit running parallel to one another, at least the first conduit, preferably the first and the second conduit, being sheathed by at least two spaced-apart insulation foils which form an evacuatable space in which a material, preferably carbon dioxide, solidifying by condensation at low temperatures and/or a gas removable by adsorption onto a getter material and also a getter material are located, and the first, second and, if appropriate, third conduit and insulation foils being surrounded by a thermally insulating sheath.

59. The conduit component as claimed in claim 58, characterized in that at least one of the insulation foils is coated with a thin metal layer.

60. The conduit component as claimed in claim 58, characterized in that the first, second and, if appropriate, third conduits are additionally also sheathed with a layer of thermally insulating material, preferably foam material.

61. The conduit component as claimed in claim 58, characterized in that the evacuatable space formed between the insulation foils also contains, in addition to the condensable gas, a finely particulate insulation material, in particular powdered silicic acid, mineral fibers or finely particulate foam materials.

62. The conduit component as claimed in claim 58, characterized in that the first and, if appropriate, the second and/or the third conduit is/are additionally sheathed with a layer of thermally insulating material, preferably foam material.

63. The conduit component as claimed in claim 45, characterized in that two or more pipelines from the first and, second conduit are combined in a composite structure.

64. The conduit component as claimed in claim 45, characterized in that a multifunction conduit is provided, in which, in addition to the first and second conduit, further conduits for material, current and/or signal transport are provided.

65. The conduit component as claimed in claim 63, characterized in that, in addition to the first and second conduit, a third conduit for the return transport of the gaseous heat transfer medium from the first heat exchanger to the second heat exchanger is provided, which is thermally insulated from the first and second conduit.

66. The conduit component as claimed in claim 63, characterized in that the first and/or second conduit contains/contain a superconducting material, and/or in that a further conduit containing superconducting material is provided.

67. The conduit component as claimed in claim 63, characterized in that the first and/or second conduit is/are designed as electrically conducting individual conduits which are provided with an electric insulation and are used as electrical conductors for current and/or signal transmissions.

68. The conduit component as claimed in claim 45, characterized in that the first conduit is coated at the location of the second heat exchanger and/or at the locations of the discharge of hydrogen from the first conduit into the third conduit with a catalyst for the conversion of parahydrogen into orthohydrogen.

69. A method for the conduit transport of cryogenic energy carriers in a conduit component as claimed in claim 45, comprising the steps:
i) feed of a gaseous and/or liquid cryogenic energy carrier into a first conduit,
ii) cooling and optionally condensation of the liquid cryogenic energy carrier at the location of the feed into the first conduit by transmission of thermal energy from the cryogenic energy carrier to a liquid heat transfer medium in a second conduit which is connected to a first heat exchanger, with the result that the heat transfer medium evaporates and is discharged from the second conduit,
iii) transport of the liquid cryogenic energy carrier through the first conduit,
iv) transport of the liquid heat transfer medium through the second conduit in countercurrent to the cryogenic energy carrier,
v) evaporation of the liquid cryogenic energy carrier at the location of the discharge from the first conduit by transmission of thermal energy from the gaseous heat transfer medium to the liquid cryogenic energy carrier in the first conduit which is connected to a second heat exchanger, with the result that the heat transfer medium condenses and is fed into the second conduit, and
vi) discharge of the gaseous cryogenic energy carrier from the first conduit.

71. The method as claimed in claim 69, characterized in that the gaseous heat transfer medium is recirculated, in a third conduit which is thermally insulated from the first and second conduit, from the first heat exchanger to the second heat exchanger and is fed there in condensed form into the second conduit again.

72. The method as claimed in claim 69, characterized in that the cryogenic energy carriers used are hydrocarbons gaseous at room temperature and/or hydrogen, in particular methane, ethane, propane, butane or their mixtures, preferably natural gas and, most especially preferably, hydrogen.

73. The method as claimed in claim 69, characterized in that the heat transfer medium used is nitrogen or, in particular, air.

74. The method as claimed in claim 69, characterized in that gaseous energy carrier which has occurred due to the evaporation of cryogenic energy carrier is transported in a third conduit running parallel to the first and second conduit.

75. The method as claimed in claim 74, characterized in that gaseous energy carrier transported in the third conduit is combined at the location of the consumer with the evaporated energy carrier discharged from the first conduit.

76. The method as claimed in claim 74, characterized in that the gaseous energy carrier transported in the third conduit is condensed at the location of the feed of the cryogenic energy carrier into the first conduit and is fed, together with this, into the first conduit.

77. A use of the conduit component as claimed in claim 45, for supplying commercial or private consumers, in particular filling stations, industrial companies, houses or dwellings, with cryogenic energy carriers, in particular with natural gas or hydrogen.

78. A pipeline for transport of cryogenic liquids, comprising a first, second and, if appropriate, third conduit running parallel to one another, at least the first conduit, preferably the first and the second conduit, being sheathed by at least two spaced-apart insulation foils which form an evaucatable space in which a material, preferably carbon dioxide, solidifying by condensation at low temperatures and/or a gas removable by absorption onto a getter material and also a getter material are located, and the first, second and, if appropriate, third conduit and insulation foils being surrounded by a thermally insulating sheath.

79. The pipeline as claimed in claim 78, characterized in that at least one of the insulation foils is coated with a thin metal layer.

80. The pipeline as claimed in claim 78, characterized in that the first conduit is coated partially or completely with a catalyst for the conversion of parahydrogen into orthohydrogen.

81. The pipeline as claimed in claim 78, characterized in that the first, second and, if appropriate, third conduit are additionally also sheathed with a layer of thermally insulating material, preferably foam material.

82. The pipeline as claimed in claim 78, characterized in that the evacuatable space formed between the insulation foils also contains, in addition to the condensable gas, a finely particulate insulation material, in particular powdered silicic acid, mineral fibers or finely particulate foam materials.

83. The pipeline as claimed in claim 78, characterized in that the first and, if appropriate, the second conduit is/are also additionally sheathed with a layer of thermally insulating material, preferably form a material.

84. The pipeline as claimed in claim 78, characterized in that further conduits for material, current and/or signal transport are provided.

85. The pipeline as claimed in claim 78, characterized in that in addition to the first and second conduit, a third conduit for the transport of gaseous heat transfer medium or evaporated gaseous cryogenic energy provided, which is preferably thermally insulated from the first and second conduit.

86. The pipeline as claimed in claim 78, characterized in that the first and/or second conduit contains/contain superconducting material, and/or in that a further conduit containing superconducting material is provided.

87. The pipeline as claimed in claim 78, characterized in that the first and/or second conduit is/are designed as electrically conducting individual conduits which are provided with an electrical insulation and are used as electrical conductors for current or signal transmissions.

88. A composite structure, comprising two or more pipelines as claimed in claim 78.

89. A power supply network, comprising at least one conduit component as claimed in claim 45.
